(19) United States
(12) Patent Application Publication
(10) Pub. No.: US 2025/0063497 A1
(43) Pub. Date: Feb. 20, 2025

(54) Power Saving Methods for Multi-Subscriber Identity Module Devices

(71) Applicant: Apple Inc., Cupertino, CA (US)

(72) Inventors: Piush Kumar, Bengaluru (IN); Nitin Kuppelur, Bengaluru (IN); Deepak Dash, Bengaluru (IN)

(21) Appl. No.: 18/450,493

(22) Filed: Aug. 16, 2023

(51) Int. Cl. H04W 52/02; H04W 12/06; H04W 48/02; H04W 48/20; H04W 60/00

(52) U.S. Cl. CPC H04W 52/0212; H04W 12/06; H04W 48/02; H04W 48/20; H04W 60/005; H04W 84/042; H04W 88/06

(57) ABSTRACT

A wireless device may transmit, using a first SIM associated with a first radio, a first attach request to a network node and transmit, using a second SIM associated with a second radio, a second attach request to the network node. Additionally, the wireless device may receive, operating in a multiple-subscriber identity module (MSIM) mode, an attach reject message including an attach reject cause code from the network node. The wireless device may transition, based at least in part on reception of the attach reject message, the second SIM to a limited service camped state, disable one of the first radio or second radio, transition to a single-SIM mode, and communicate with the network node via the first SIM.

### FIELD

The present application relates to wireless devices, and more particularly to apparatuses, systems, and methods for coordinating communication and providing power saving techniques for multi-subscriber identity module devices in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), BLUETOOTH™, etc.

The increasing number of features and functionality introduced in wireless communication devices also creates a continuous need for improvement in both wireless communications and in wireless communication devices. In particular, it is important to ensure the accuracy of transmitted and received signals through user equipment devices (UEs), e.g., through wireless devices such as cellular phones, base stations and relay stations used in wireless cellular communications. For example, some UEs may include multiple subscriber identity modules (SIMs) which may be active concurrently. Under some circumstances, collisions may occur between transmissions to such UEs associated with different SIMs. Such collisions may negatively impact user experience and performance of the UE. In addition, increasing the functionality of a UE device can place a significant strain on the battery life of the UE device. For example, certain paging schedules for different SIMs may require increased power use. Thus, it is very important to also reduce power requirements in UE device designs while allowing the UE device to maintain good transmit and receive abilities for improved communications.

To increase coverage and better serve the increasing demand and range of envisioned uses of wireless communication, in addition to the communication standards mentioned above, there are further wireless communication technologies under development, including fifth generation (5G) new radio (NR) communication. Accordingly, improvements in the field in support of such development and design are desired.

### SUMMARY

Embodiments relate to apparatuses, systems, and methods for methods for coordinating communication and providing power saving techniques for multi-subscriber identity module devices in a wireless communication system.

According to some embodiments, a wireless device may transmit, using a first SIM associated with a first radio, a first attach request to a network node and transmit, using a second SIM associated with a second radio, a second attach request to the network node. Additionally, the wireless device may receive, operating in a multiple-subscriber identity module (MSIM) mode, an attach reject message including an attach reject cause code from the network node. The wireless device may transition, based at least in part on reception of the attach reject message, the second SIM to a limited service camped state, disable one of the first radio or second radio, transition to a single-SIM mode, and communicate with the network node via the first SIM.

In some embodiments, the attach reject cause code may be an Attach Reject Cause #6 associated with an illegal mobile equipment (ME). Additionally or alternatively, the attach reject message may be non-integrity (non-IP) protected. In some embodiments, the limited service camped state may provide emergency services for the wireless device. According to further embodiments, the at least one processor may be further configured to cause the wireless device to transition the second SIM out of the limited service camped state upon completion of a power cycle.

In some instances, the at least one processor may be further configured to cause the wireless device to receive, on the first SIM, an attach accept message from the network node and transition, based at least in part on performing a successful registration procedure, to a registered idle state. Additionally, the at least one processor may be further configured to cause the wireless device to receive, on the second SIM, an authentication request from the network node and transmit, on the second SIM, an authentication response to the network node. Furthermore, the at least one processor may be further configured to cause the wireless device to receive, on the second SIM, an authentication reject message from the network node, wherein the second SIM is transitioned to a limited service camped state based at least in part on reception of the authentication reject message. Additionally or alternatively, the first SIM may provide emergency services and normal services based at least in part on being in the registered idle state.

According to further embodiments, a method by a UE may include operating in a MSIM mode and transmitting, using a first radio associated with a first SIM, a first registration request to a network node. The method may further include transitioning, based at least in part on performing a successful registration procedure associated with a first cell of the network node, the first SIM to a registered idle state and transmitting, using a second radio associated with a second SIM, a second registration request to the network node. The method may additionally include receiving, using the second radio, a registration reject message from the network node. In some embodiments, the registration reject message may include a registration reject cause code associated with a second cell of the network node. The method may further include barring the second cell and performing a cell selection procedure in which the second cell is barred from being selected in the cell selection procedure. According to some embodiments, the registration reject message may be a non-IP registration reject message.

Additionally, the method may further include, starting, upon reception of the registration reject message, one or more timers. In some embodiments, the one or more timers may include a T3245 timer and the method may further include marking the second SIM as invalid for a duration of the T3245 timer. Additionally or alternatively, the one or more timers may include a T3247 timer and the method may further include incrementing a counter of the timer, marking a tracking area (TA) associated with the second cell as forbidden, and searching for a TA other than the forbidden TA. In some embodiments, the registration reject cause code may be a Registration Reject Cause #6 associated with an illegal mobile equipment (ME).

According to other embodiments, an apparatus may include at least one processor of a UE operating in a MSIM mode and the at least one processor may be configured to cause the UE to transmit, to a public land mobility network (PLMN) and using a first radio associated with a first SIM, a first registration request associated with a first tracking area identifier (TAI). The at least one processor may be further configured to cause the UE to receive, using the first radio, a registration reject message from the network node in which the registration reject message may include a registration reject cause code. The at least one processor may be further configured to cause the UE to start one or more timers, mark the first TAI as forbidden, and search for a second TAI excluding the first TAI.

In some embodiments, the at least one processor may be further configured to cause the UE to transmit, to the PLMN and using the second radio, a second registration request associated with the second TAI and receive, from the PLMN and using the second SIM, a registration accept message. The at least one processor is further configured to cause the UE to transmit, to the PLMN and using the first radio associated with the first SIM, a third registration request associated with the second TAI and receive, from the PLMN and using the first radio associated with the first SIM, a second registration accept message, according to some embodiments. Additionally or alternatively, the one or more timers may include a T3247 timer and the at least one processor may be further configured to cause the UE to increment a counter of the T3247 timer upon reception of a registration reject message from the PLMN. According to some embodiments, the registration reject message may be a non-IP non-access stratum (NAS) reject message.

In some embodiments, when the counter of the T3247 timer is incremented, the at least one processor may be further configured to cause the UE to update, upon reception of respective registration reject messages, a list of forbidden TAIs to include respective forbidden TAIs associated with the respective registration request messages. Additionally or alternatively, when the counter of the T3247 timer reaches a maximum value, the at least one processor may be further configured to cause the UE to perform a cell search procedure in a different TAI.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system, according to some embodiments;

FIG. 2 illustrates a base station (BS) in communication with a user equipment (UE) device, according to some embodiments;

FIG. 3 illustrates an example block diagram of a UE, according to some embodiments;

FIG. 4 illustrates an example block diagram of a BS, according to some embodiments;

FIG. 5 illustrates an example block diagram of cellular communication circuitry, according to some embodiments;

FIGS. 6 and 7 illustrate examples of a 5G NR base station (gNB), according to some embodiments; and

FIG. 8 is a communication flow diagram illustrating example aspects of MSIM device operations in which multiple SIMs are in a limited service camped state, according to some embodiments;

FIG. 9 is a communication flow diagram illustrating example aspects of MSIM device power saving techniques to avoid both SIMs being in limited service camped states, according to some embodiments;

FIG. 10 is a communication flow diagram illustrating example aspects of MSIM device operations in which one SIM is able to register successfully and another SIM receives an authentication rejection, according to some embodiments;

FIG. 11 is a communication flow diagram illustrating an example method of MSIM power saving techniques in which one SIM is operating in a normal registered state and the other SIM is in a limited service camped state, according to some embodiments;

FIG. 12 is a communication flow diagram illustrating example aspects of MSIM device operations in which one SIM is operating in a normal registered state and the other SIM receives a non-integrity protected registration reject message, according to some embodiments;

FIG. 13 is a communication flow diagram illustrating an example method for power saving in a scenario in which one SIM is operating in a normal registered state and the other SIM has received a non-integrity protected registration reject message, according to some embodiments;

FIG. 14 is a communication flow diagram illustrating an alternate method for power saving in a scenario in which one SIM is operating in a normal registered state and the other SIM has received a non-integrity protected registration reject message, according to some embodiments;

FIG. 15 is a communication flow diagram illustrating example aspects of MSIM device operations in which both SIMs from the same PLMN follow a looping procedure after receiving a non-integrity protected registration reject message, according to some embodiments; and

FIG. 16 is a communication flow diagram illustrating an example method for power saving in a scenario in which one SIM receives a non-integrity protected registration reject message and attempts to camp in a second tracking area, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
TS: Technical Specification
RAN: Radio Access Network
RAT: Radio Access Technology
UE: User Equipment
RF: Radio Frequency
BS: Base Station
DL: Downlink
UL: Uplink
LTE: Long Term Evolution
NR: New Radio
5GS: 5G System
5GMM: 5GS Mobility Management
5GC: 5G Core Network
IE: Information Element
TX: Transmission/Transmit
RX: Reception/Receive
WLAN: Wireless LAN
EPC: Evolved Packet Core
IEEE: Institute of Electrical and Electronics Engineers
Wi-Fi: Wireless Local Area Network (WLAN) RAT based on IEEE 802.11 Standards
MUSIM/MSIM: Multiple Subscriber Identity Module
USIM: Universal Subscriber Identity Module
SIM: Subscriber Identity Module.
DDS: Default Data SIM
nDDS: Non-Default Data SIM
EN-DC: Enhanced Dual Connectivity
MME: Mobility Management Entity
GSMA: Groupe Speciale Mobile Association
IMEI: International Mobile Station Equipment Identity
ME: Mobile Equipment
NAS: Non-Access Stratum
DoS: Denial of Service.
NG-RAN: Next Generation Radio Access Network
gNB: Next Generation Node-B
UICC: Universal Integrated Circuit Card
MS: Mobile Station
TA: Tracking Area
TAI: Tracking Area Identity.
PLMN: Public Land Mobility Network
GPRS: General Packet Radio Service
NW: Network

### Terms

The following is a glossary of terms used in this disclosure:

Memory Medium-Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium-a memory medium as described above, as well as a physical transmission medium, such as a bus, network, and/or other physical transmission medium that conveys signals such as electrical, electromagnetic, or digital signals.

Programmable Hardware Element-includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System-any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g. smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

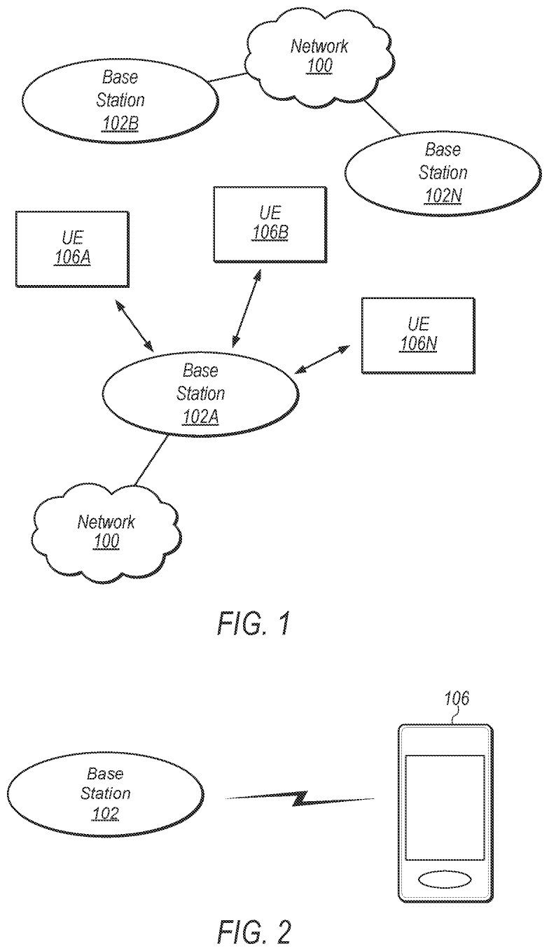

### FIGS. 1 and 2—Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”), and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station).

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR. HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer, a laptop, a tablet, a smart watch or other wearable device, or virtually any type of wireless device.

The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

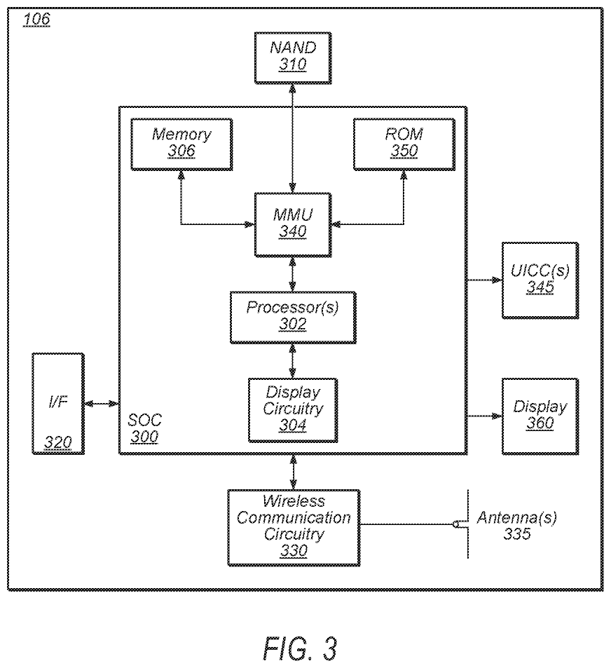

### FIG. 3—Block Diagram of a UE

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, etc.). In some embodiments, communication device 106 may include wired communication circuitry (not shown), such as a network interface card, e.g., for Ethernet.

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include one or more receive chains (including and/or coupled to (e.g., communicatively; directly or indirectly) dedicated processors and/or radios) for multiple RATs (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with a second radio. The second radio may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, etc.) configured to perform the functions of wireless communication circuitry 330.

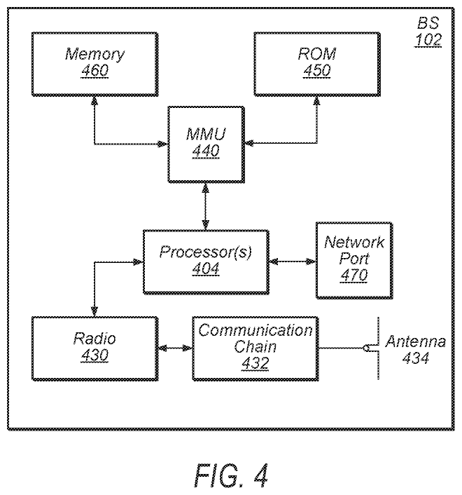

### FIG. 4—Block Diagram of a Base Station

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

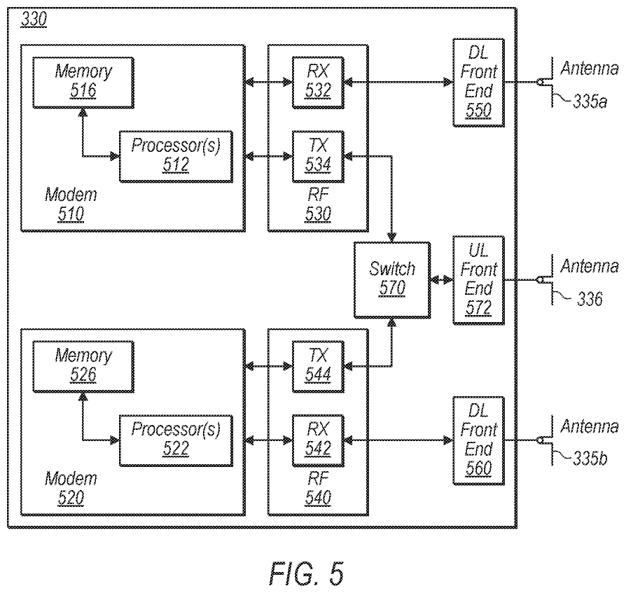

### FIG. 5—Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown. In some embodiments, cellular communication circuitry 330 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 330 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more processing elements. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some embodiments, the cellular communication circuitry 330 may include only one transmit/receive chain. For example, the cellular communication circuitry 330 may not include the modem 520, the RF front end 540, the DL front end 560, and/or the antenna 335b. As another example, the cellular communication circuitry 330 may not include the modem 510, the RF front end 530, the DL front end 550, and/or the antenna 335a. In some embodiments, the cellular communication circuitry 330 may also not include the switch 570, and the RF front end 530 or the RF front end 540 may be in communication, e.g., directly, with the UL front end 572.

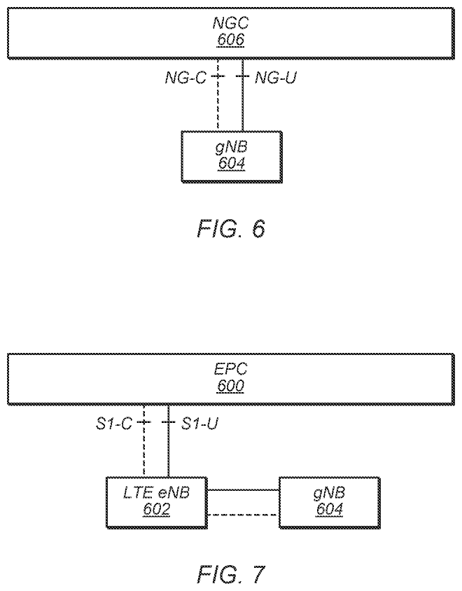

### FIGS. 6—7-5G NR Architecture

In some implementations, fifth generation (5G) wireless communication will initially be deployed concurrently with other wireless communication standards (e.g., LTE). For example, whereas FIG. 6 illustrates a possible standalone (SA) implementation of a next generation core (NGC) network 606 and 5G NR base station (e.g., gNB 604), dual connectivity between LTE and 5G new radio (5G NR or NR), such as in accordance with the non-standalone (NSA) architecture illustrated in FIG. 7, has been specified as part of the initial deployment of NR. Thus, as illustrated in FIG. 7, evolved packet core (EPC) network 600 may continue to communicate with current LTE base stations (e.g., eNB 602). In addition, eNB 602 may be in communication with a 5G NR base station (e.g., gNB 604) and may pass data between the EPC network 600 and gNB 604. In some instances, the gNB 604 may also have at least a user plane reference point with EPC network 600. Thus, EPC network 600 may be used (or reused) and gNB 604 may serve as extra capacity for UEs, e.g., for providing increased downlink throughput to UEs. In other words, LTE may be used for control plane signaling and NR may be used for user plane signaling. Thus, LTE may be used to establish connections to the network and NR may be used for data services. As will be appreciated, numerous other non-standalone architecture variants are possible.

### Power Saving Methods for Multi-Subscriber Identity Module Devices

In some embodiments, the UE 106 may include multiple subscriber identity modules (SIMs, sometimes referred to as SIM cards). In other words, the UE 106 may be a multi-SIM (MUSIM) device, such as a dual-SIM device. Any of the various SIMs may be physical SIMs (e.g., SIM cards) or embedded (e.g., virtual) SIMs. Any combination of physical and/or virtual SIMs may be included. Each SIM may provide various services (e.g., packet switched and/or circuit switched services) to the user. In some embodiments, UE 106 may share common receive (Rx) and/or transmit (Tx) chains for multiple SIMs (e.g., UE 106 may have a dual SIM dual standby (DSDS) architecture). Other architectures are possible. For example, UE 106 may be a dual SIM dual active (DSDA) architecture, may include separate Tx and/or Rx chains for the various SIMs, may include more than two SIMs, etc.

The different identities (e.g., different SIMs) may have different identifiers, e.g., different UE identities (UE IDs). For example, an international mobile subscriber identity (IMSI) may be an identity associated with a SIM (e.g., in a MUSIM device each SIM may have its own IMSI. The IMSI may be unique. Similarly, each SIM may have its own unique international mobile equipment identity (IMEI). Thus, the IMSI and/or IMEI may be examples of possible UE IDs, however other identifiers may be used as UE ID.

The different identities may have the same or different relationships to various public land mobile networks (PLMNs). For example, a first identity may have a first home PLMN, while a second identity may have a different home PLMN. In such cases, one identity may be camped on a home network (e.g., on a cell provided by BS 102) while another identity may be roaming (e.g., while also camped on the same cell provided by BS 102, or a different cell provided by the same or different BS 102). In other circumstances, multiple identities may be concurrently home (e.g., on the same or different cells of the same or different networks) or may be concurrently roaming (e.g., on the same or different cells of the same or different networks). As will be appreciated, numerous combinations are possible. For example, two SIM subscriptions on a MUSIM device may belong to the same equivalent/carrier (e.g., AT&T/AT&T or CMCC/CMCC). As another possibility, SIM-A may be roaming into SIM-B's network (SIM-A CMCC user roaming into AT&T and SIM-B is also AT&T).

Furthermore, for a UE with a MUSIM configuration (e.g., SIM1 and SIM2) in DSDS architecture, when the UE performs an RF (radio frequency) re-tuning from SIM1 to SIM2, Tx/Rx may be suspended for SIM1. However, for UEs supporting 5G NR mm Wave frequencies, a dedicated FR2 Tx/Rx RF capability may be included as hardware in the UE while some current MUSIM designs may not take full benefit of this capability. For example, a UE with a MUSIM configuration including a SIM1 with support for LTE and FR2 (mmWave) with active packet switching may be considered a data preferred or data default SIM (DDS). Additionally, in some examples, certain high-range FR1 frequencies may also use a dedicated Tx/Rx. The UE may also include a non-data or non-data default SIM (e.g., SIM2) with support for LTE but not FR2 (mmWave). Accordingly, there may exist a scenario in which the UE is operating in enhanced dual connectivity (EN-DC) mode with SIM1 active and upon SIM2 receiving or placing a voice call, SIM1 may become out of service due to the suspension of Tx/Rx on SIM1. For a UE with a MUSIM configuration in DSDA architecture, there may not be a suspension of Tx/Rx capability on both SIM1 and SIM2.

### Network Rejection Handling for MSIM Devices

Groupe Speciale Mobile Association (GSMA) has provided input for scenarios above involving Multi-SIM devices in the event that the UE or ME receives a “Network Reject cause #6” on any of its MSIM instances. More specifically, GSMA has provided instructions for networks and UEs to ensure the correct operation of regulator-mandated (or voluntary) procedures to block the use of stolen devices on mobile networks. However, while the instructions provide measures of enhanced security, some power conservation techniques used in tandem with the security related instructions may be beneficial to prolong battery life in UEs. Accordingly, it may be beneficial to provide power saving methods for various scenarios involving MSIM devices receiving cause code reject #6“Illegal ME” on one or more of its SIMs.

For example, in some security related instances, it may be necessary to block service access from one of the device's IMEIs which may further result in the entire device being blocked. More specifically, if a device receives a reject #6“Illegal ME” over one 3GPP/connection, it may be necessary to block operation on all 3GPP/3GPP2 connections. Similarly, if a “Lock until Power-Cycled Order” is received over one 3GPP2 connection, the device may block operation on all 3GPP/3GPP2 connections. For example, if a device (e.g., a user equipment (UE)) and/or a IMEI associated with the device has been labeled as an illegal mobile equipment (ME), the network may determine to block service access for the IMEI. This labeling of an ME as being “illegal” may be associated with a user reporting the ME as having been stolen, according to some instances.

Furthermore, there may be scenarios in which NW rejection handling can be optimized for an MSIM UE. For example, one power saving method may involve turning off the radio for a first MSIM instance when transitioning to a limited service camped state (until a power cycle is performed) when the other MSIM instance is already in a normal or limited camped state. This disabling of the first radio may help enhance the battery life of the UE.

Additionally, scenarios involving an MSIM device (e.g., a MSIM UE) receiving a non-integrity protected NW Reject message to invalidate the SIM may benefit from enhanced denial of service (DOS) handling mechanisms or methods. These enhanced methods may help in reducing unnecessary signaling loads and identifying fraudulent networks more quickly. Thus, the user experience may be improved from these enhancements.

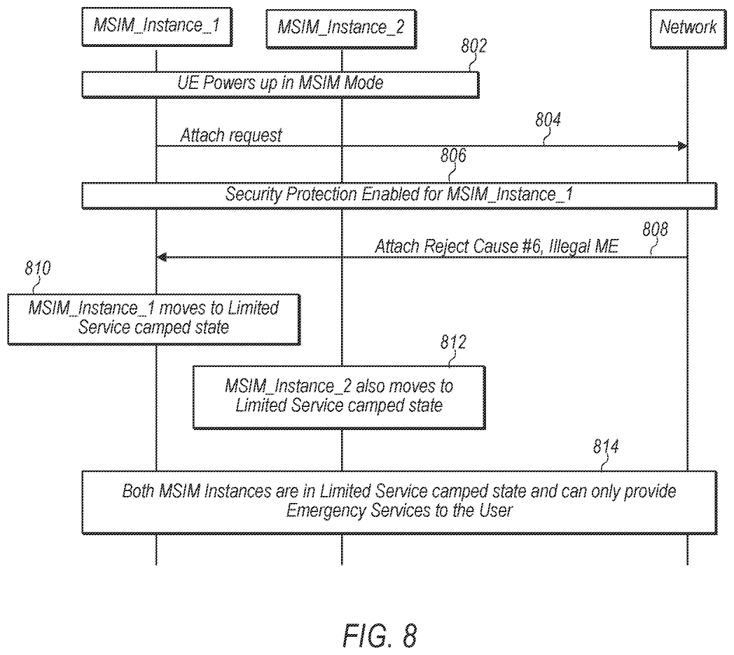

### FIG. 8—MSIM Operation in Limited Service Camped States

FIG. 8 is a communication flow diagram illustrating example aspects of MSIM device operations in which multiple SIMs are in a limited service camped state, according to some embodiments. For example, if a user equipment (UE) (e.g., a wireless device) complies with the aforementioned MSIM device GSMA instructions, if the MSIM UE receives a reject #6“Illegal ME” cause code for one of its IMEI (e.g., a first SIM), the wireless device should treat the other IMEI (e.g., a second SIM) similarly. In other words, the UE should block the SIM for which it received the reject #6 cause code as well as the other SIM (e.g., other IMEI) from receiving appropriate 3GPP services, according to some embodiments.

In such a scenario, the UE may have access to only limited services and the first SIM may be marked as invalid. For example, having received the attach reject cause code #6 which may indicate that the first SIM is associated with a stolen wireless device, the UE may move the first and second SIMs to a limited service camped state. In other words, multiple MSIM instances in the UE may be in limited service camped states at the same time, according to some embodiments. Furthermore, the limited service camped states may be associated with the MSIM instances only providing emergency services to the user, according to some embodiments. For example, in the limited services camped states, the MSIM instances may still have access to Emergency Services (e.g., such as being able to place an emergency call such as 9-1-1 in the United States of America).

Accordingly, if the reject cause code #6 was received as an integrity protected message and the UE was not configured to use timer T3245, the UE may remain in the limited service camped state on multiple MSIM instances until a power-cycle is performed. Therefore, in this scenario, it may be beneficial for the UE to disable one of the MSIM instances to avoid draining its battery and/or provide a measure of power conservation while maintaining emergency services on the other MSIM instance.

FIG. 8 illustrates an example communication flow diagram between a network and a first SIM (MSIM_Instance_1) and a second SIM (e.g., MSIM_Instance_2), according to some embodiments. More specifically, in 802, the UE may power up in a MSIM mode which supports the use of both MSIM_Instance_1 and MSIM_Instance_2. In 804, MSIM_Instance_1 may be used to transmit an attach request to the network and in 806, the network may enable security protection for MSIM_Instance_1, according to some embodiments. For example, enabling security protection for MSIM_Instance_1 may allow for secure exchange of non-access stratum (NAS) messages.

Additionally, in 808, the network may transmit an attach reject cause #6 code to MSIM_Instance_1 which may indicate that the UE is an illegal ME (e.g., the ME or UE may have been reported as stolen). Accordingly, in 810, MSIM_Instance_1 may, in response to receiving the attach reject cause code #6 and in accordance with the aforementioned GSMA instructions, transition to a limited service camped state. Furthermore, in 812, MSIM_Instance_2 may also transition to a limited service camped state. Accordingly, as shown in 814, the UE may only be provided emergency services since both MSIM_Instance_1 and MSIM_Instance_2 are in limited service camped states, according to some embodiments.

In some embodiments related to FIG. 8, the first SIM may instead be MSIM_Instance_2 and the second SIM may be MSIM_Instance_1 such that their roles are reversed with regard to the methods performed in 802-814.

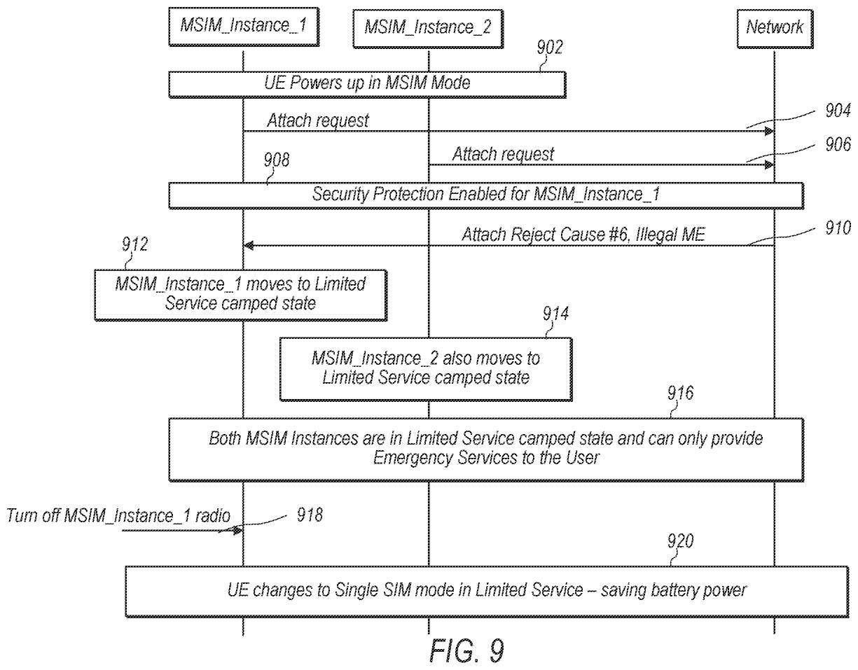

### FIG. 9—Power Saving Techniques for MSIM Operation Involving Limited Service Camped States

FIG. 9 is a communication flow diagram illustrating example aspects of MSIM device power saving techniques to avoid both SIMs being in limited service camped states, according to some embodiments. More specifically and related to the scenario of FIG. 8, the UE may only have access to emergency services since both the first SIM and the second SIM have transitioned to the limited service camped mode/state. Accordingly, while GSMA instructions may provide measures of security enhancements, it may not be necessary for both MSIM instances to be enabled since emergency services can be provided via one of the MSIM instances.

For example, in 902, the UE may power up in a MSIM mode which supports the use of both a first SIM (e.g., MSIM_Instance_1) and a second SIM (e.g., MSIM_Instance_2). In 904, MSIM_Instance_1 may be used to transmit an attach request to the network and in 906, MSIM_Instance_2 may also be used to transmit an attach request to the network. In response, the network may in 908 enable security protection for MSIM_Instance_1, according to some embodiments.

Furthermore, in 910, the network may transmit an attach reject cause #6 code to MSIM_Instance_1 which may indicate that the UE is an illegal ME. Accordingly, in 912 MSIM_Instance_1 may, in response to receiving the attach reject cause code #6 and in accordance with the aforementioned GSMA instructions, transition to a limited service camped state. MSIM_Instance_2 may in 914 further transition to a limited service camped state in response to MSIM_Instance_1 similarly transitioning. Therefore, as shown in 916, the UE may only be provided emergency services since both MSIM_Instance_1 and MSIM_Instance_2 are in limited service camped states, according to some embodiments.

Accordingly, in 918, the UE may be able to disable or turn off a radio associated with MSIM_Instance_1 while a different radio associated with MSIM_Instance_2 remains enabled to provide emergency services to the UE. Therefore, in 920, the UE may switch or transition to a single SIM mode since the radio for MSIM_Instance_1 is disabled. This disabling of the radio may provide a measure of power conservation to extend the battery life of the UE due to reduced transmissions associated with the disabled radio.

In other words, in the scenario in which MSIM_Instance_1 (e.g., the first SIM) has transitioned to a limited service camped state (until a power cycle is performed) due to a rejection cause code from the network (e.g., cause code #6), it may be beneficial to turn off the radio for the first SIM. The UE may then be associated with a single SIM mode in limited service. Accordingly, by turning off the radio for MSIM_Instance_1, this may help to save or conserve the UE's battery power.

For example, according to some embodiments related to FIG. 9, a wireless device may transmit, using a first SIM associated with a first radio, a first attach request to a network node and transmit, using a second SIM associated with a second radio, a second attach request to the network node. Additionally, the wireless device may receive, operating in a multiple-subscriber identity module (MSIM) mode, an attach reject message including an attach reject cause code from the network node. The wireless device may transition, based at least in part on reception of the attach reject message, the second SIM to a limited service camped state, disable one of the first radio or second radio, transition to a single-SIM mode, and communicate with the network node via the first SIM.

In some embodiments, the attach reject cause code may be an Attach Reject Cause #6 associated with an illegal mobile equipment (ME). Additionally or alternatively, the attach reject message may be non-integrity (non-IP) protected. In some embodiments, the limited service camped state may provide emergency services for the wireless device. According to further embodiments, the at least one processor may be further configured to cause the wireless device to transition the second SIM out of the limited service camped state upon completion of a power cycle.

In some embodiments related to FIG. 9, the first SIM may instead be MSIM_Instance_2 and the second SIM may be MSIM_Instance_1 such that their roles are reversed with regard to the methods performed in 902-920.

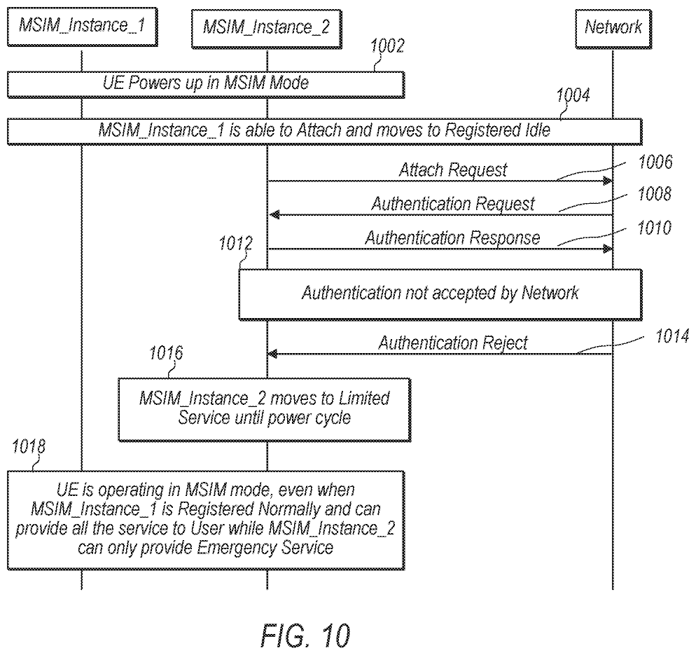

### FIG. 10—MSIM Operation Involving Normal Registered and Limited Service Camped States

FIG. 10 is a communication flow diagram illustrating example aspects of MSIM device operations in which one SIM is able to register successfully and another SIM receives an authentication rejection, according to some embodiments.

In some embodiments, if the UE is operating in MSIM mode and SIM_Instance_1 (e.g., a first SIM) is able to register normally while the SIM_Instance_2 (e.g., a second SIM) marks the universal SIM (USIM) as invalid, the UE may receive an integrity protected Authentication Reject. More specifically, the UE may receive an integrity protected Attach Reject cause #7 indicating that EPS services are not allowed for that particular IMEI (e.g., a second SIM associated with MSIM_Instance_2). Accordingly, the second SIM (e.g., MSIM_Instance_2) may move to a Limited Service camped mode until it performs a power cycle. In other words, because the UE is operating in MSIM mode and the other SIM instance (e.g., the first SIM) might be operating in a normal registered service, there may be no use for the UE to have the second SIM in a Limited Service camped mode until the power cycle is performed.

For example, FIG. 10 illustrates that a UE may power up in a MSIM mode in 1002. In 1004, the first SIM (e.g., MSIM_Instance_1) may then attach to the network and further more to a registered idle state. In 1006, the second SIM (e.g., MSIM_Instance_2) may also send an attach request to the network and receive an authentication request in 1008. Accordingly, the UE may, via MSIM_Instance_2, transmit an authentication response in 1010 to the network in response to the request in 1008.

In 1012, the network may not accept the authentication provided by MSIM_Instance_2 in 1010, according to some embodiments. Accordingly, the network may transmit an authentication reject message in 1014 and MSIM_Instance_2 may in 1016 move to a limited service camped state until a power cycle is performed. Therefore, at 1018, the UE may be operating in a MSIM mode with MSIM_Instance_1 in a normal registered idle state while MSIM_Instance_2 is in a limited services camped state, according to some embodiments. However, having a MSIM instance in the limited service camped state may be unnecessary since one SIM can provide emergency services as well as normal registered services (e.g., data communications and/or voice calling) to the UE. Accordingly, in this scenario, it may be beneficial for the UE to disable a MSIM instance in limited service to avoid draining its battery and/or provide a measure of power conservation.

In some embodiments related to FIG. 10, the first SIM may instead be MSIM_Instance_2 and the second SIM may be MSIM_Instance_1 such that their roles are reversed with regard to the methods performed in 1002-1018.

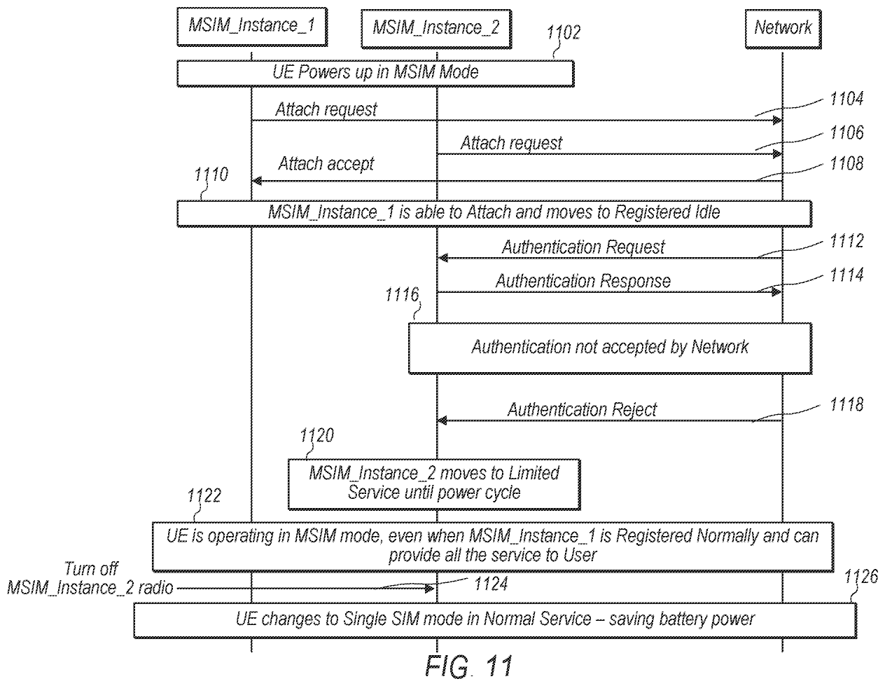

### FIG. 11—Power Saving Techniques for MSIM Operation Involving Normal Registered and Limited Service Camped States

FIG. 11 is a communication flow diagram illustrating an example method of MSIM power saving techniques in which one SIM is operating in a normal registered state and the other SIM is in a limited service camped state, according to some embodiments.

According to some embodiments related to the scenario of FIG. 10, the UE may have access to normal registered services via MSIM_Instance_1 (e.g., the first SIM) and Limited Service (e.g., emergency services only) via MSIM_Instance_2 in the Limited Services camped mode. More specifically, having received an integrity protected authentication reject or an Attach Reject cause code (e.g., cause code #7) indicating that EPS services are not allowed for MSIM_Instance_2 (e.g., the second SIM), the UE may follow appropriate procedures (e.g., GSMA procedures or instructions) to block the second SIM from receiving appropriate 3GPP services by transitioning it to the limited service camped state until a power cycle is performed.

For example, in 1102, a UE may power up and be operating in a MSIM mode. Accordingly, in 1104 and 1106, MSIM_Instance_1 and MSIM_Instance_2 may send attach requests to the network. In 1108, the network may transmit an attach accept message to MSIM_Instance_1 and in 1110 MSIM_Instance_1 may transition to a registered idle state, according to some embodiments.

According to some embodiments, in 1112, the network may transmit an authentication request. Accordingly, the UE may, via MSIM_Instance_2, transmit an authentication response in 1114 to the network in response to the request of 1112. In 1116, the network may not accept the authentication provided by MSIM_Instance_2 in 1114 and transmit an authentication reject message in 1118, according to some embodiments. Alternatively, the network may transmit an Attach Reject which may include a reject cause code such as cause code #7 indicating that EPS services are not allowed for MSIM_Instance_2.

Accordingly, at 1120, MSIM_Instance_2 may transition to a limited service camped state until a power cycle is performed. In other words, MSIM_Instance_2 may receive an integrity protected Authentication Reject or an integrity protected Attach Reject with cause code #7 and each of these reject messages may transition MSIM_Instance_2 to a limited service camped state until a power cycle is performed, according to some embodiments. Therefore, at 1122, the UE may be operating in a MSIM mode with MSIM_Instance_1 in a normal registered idle state while MSIM_Instance_2 is in a limited services camped state, according to some embodiments. However, having one of the MSIM instances in the limited service camped state may be unnecessary since the other normally registered SIM (e.g., MSIM_Instance_1) can provide emergency services as well as normal registered services (e.g., data communications and/or voice calling) to the UE.

Therefore, in the scenario in which MSIM_Instance_2 has transitioned to a limited service camped state (until a power cycle is performed) due to an authentication reject or an attach reject cause code from the network (e.g., cause code #7), it may be beneficial to turn off the radio for MSIM_Instance_2. At 1124, the UE may disable or turn off a radio associated with MSIM_Instance_2 and the UE may then be associated with a single SIM mode in normal service. Accordingly, by turning off the radio for MSIM_Instance_1, this may help to save or conserve the UE's battery power through reduced transmissions via MSIM_Instance_2.

For example, in some instances related to FIG. 11, a wireless device may receive, on the first SIM, an attach accept message from the network node and transition, based at least in part on performing a successful registration procedure, to a registered idle state. Additionally, the wireless device may receive, on the second SIM, an authentication request from the network node and transmit, on the second SIM, an authentication response to the network node. Furthermore, the wireless device may receive, on the second SIM, an authentication reject message from the network node, wherein the second SIM is transitioned to a limited service camped state based at least in part on reception of the authentication reject message. Additionally or alternatively, the first SIM may provide emergency services and normal services based at least in part on being in the registered idle state.

In some embodiments related to FIG. 11, the first SIM may instead be MSIM_Instance_2 and the second SIM may be MSIM_Instance_1 such that their roles are reversed with regard to the methods performed in 1102-1126.

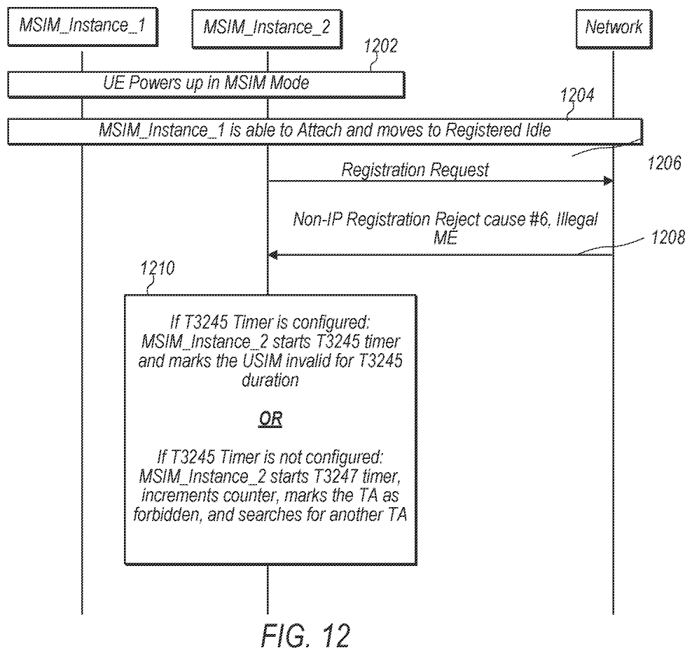

### FIG. 12—MSIM Operation in Normal Registered States Involving Non-Integrity Protected Registration Reject Messages

Recently, 3GPP specifications have provided instructions for UEs in the handling of 5GS Mobility Management (5GMM) reject messages which are received without integrity protection before the network has established secure exchange of NAS messages. More specifically, when an unsolicited NAS reject message without security protection is sent by a malicious network, it may result in denial of service (DOS) attack on a victim UE. For instance, normal processing of an unprotected registration reject message triggered by a false or fake next generation radio access network/next generation Node-B (NG-RAN/gNB) including a fatal reject cause such as the value or cause code #6“Illegal ME” may lead to the UE consider or mark the Universal Subscriber Identity Module (USIM) as invalid for 5GS services until switching off (e.g., performing a power cycle) or until the Universal Integrated Circuit Card (UICC) containing the USIM is removed, according to some embodiments.

However, older implementations or operations of networks may still send non-integrity protected reject messages. Accordingly, non-integrity protected messages should not be disregarded or discarded completely and therefore a method or mechanism for handling said messages may provide enhanced benefits to the UE.

FIG. 12 is a communication flow diagram illustrating example aspects of MSIM device operations in which one SIM is operating in a normal registered state and the other SIM receives a non-integrity protected registration reject message, according to some embodiments.

For example, as shown in FIG. 12, at 1202 a UE may power up in a MSIM mode and a first sim (e.g., MSIM_Instance_1) may subsequently attach to a network and move to a registered idle state in 1204. In 1206, a second SIM (e.g., MSIM_Instance_2) may transmit a registration request to the network and in 1208 receive a non-integrity protected (non-IP) registration reject message. More specifically, at 1208, the network may transmit a non-IP registration reject message associated with or including a cause code #6 which may indicate that the MSIM_Instance_2 corresponds to an illegal ME, according to some embodiments.

Accordingly, in 1210, MSIM_Instance_2 may start a T3245 timer and mark the USIM as invalid for the duration of the T3245 timer. In other words, MSIM_Instance_2 may be considered as invalid for registration with the network until expiry of the T3245 timer. Alternatively, if the MSIM_Instance_2 does not have a T3245 timer configured, the MSIM_Instance_2 may start a T3247 timer. Additionally, the MSIM_Instance_2 may increment a counter of the T3247 timer as well as mark the corresponding tracking area (TA) associated with network registration attempt as forbidden. In some embodiments, the MSIM_Instance_2 may then search for another TA while excluding the forbidden TA.

In other words, a mechanism for DOS attack prevention when UEs receive non-IP reject cause #6 may involve the UE starting a timer T3245 with a random value uniformly drawn from the range between 12 h and 24 h (as one example range) and marking the USIM as invalid for this duration, according to some embodiments. Alternatively, if the UE is not configured to use the T3245 timer, the UE may instead start a T3247 timer with a random value uniformly drawn from the range between 30 minutes and 60 minutes (as one example range) and maintain a counter for “SIM/USIM considered invalid for GPRS services” events and increment the counter until it reaches a UE defined maximum value. The UE may then keep searching the cell in a different TA. Additionally, such a mechanism for MSIM devices may be extended to all the 3GPP RATs, according to some embodiments.

For example, when a MSIM UE receives a non-integrity protected Reject Cause #6 Illegal ME on one MSIM instance, the other MSIM instance may still be able to register normally with security enabled. One 3GPP approach may take multiple attempts from the device and there may result in an additional signaling load on the network side. Additionally, in the case of a fraudulent network sending said non-integrity protected reject cause #6, the UE may be denied any service until the T3245 or T3247 timers have reached their duration, according to some embodiments.

Thus, while previous 3GPP methods for addressing the non-integrity protected reject cause messages may ignore the extra information and flexibility that MSIM devices may possess, the aforementioned mechanism(s) may help the UE to identify the fraudulent network in less time and take responsive actions to mitigate delays and/or provide power conservation.

In some embodiments related to FIG. 12, the first SIM may instead be MSIM_Instance_2 and the second SIM may be MSIM_Instance_1 such that their roles are reversed with regard to the methods performed in 1202-1210.

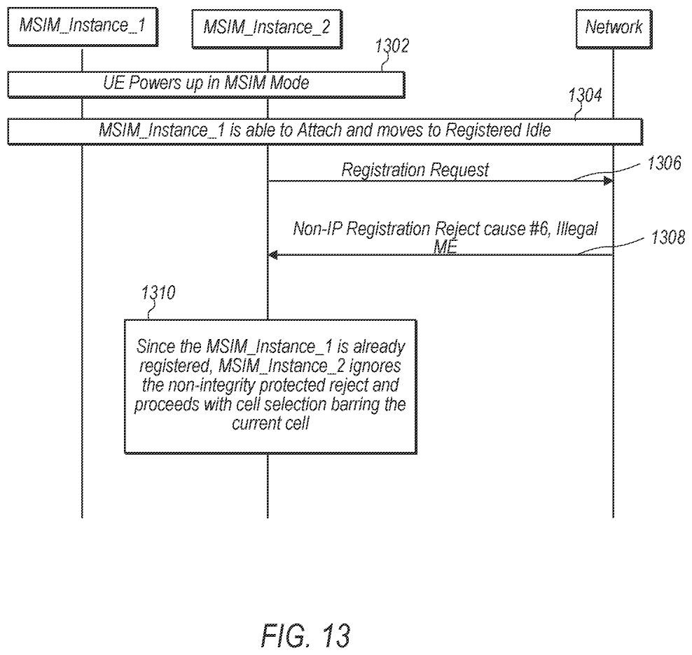

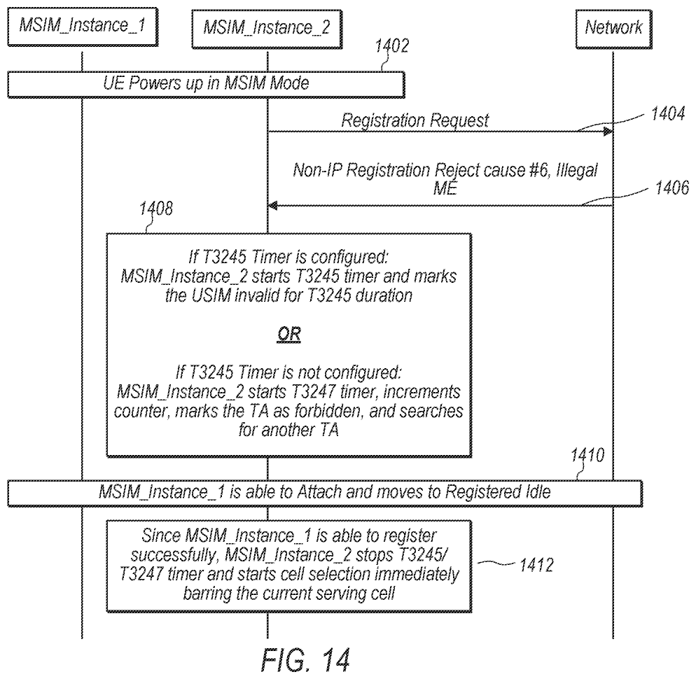

### FIGS. 13 and 14—Power Saving Methods for MSIM Operation Involving Non-Integrity Protected Registration Reject Messages

FIG. 13 is a communication flow diagram illustrating an example method for power saving in a scenario in which one SIM is operating in a normal registered state and the other SIM has received a non-integrity protected registration reject message, according to some embodiments.

For example, in 1302, a UE may power up in a MSIM mode and a first SIM (e.g., MSIM_Instance_1) may send an attach request to a network. Accordingly in 1304, MSIM_Instance_1 may be able to attach and move to a registered idle state. Similarly, a second SIM (e.g., MSIM_Instance_2) may send a registration request to the network in 1306 but receive a non-IP registration reject cause #6,Illegal ME message from the network in 1308. However, in 1310, since MSIM_Instance_1 has already transitioned to a registered state, MSIM_Instance_2 may be able to ignore the non-IP reject and proceed with cell selection and barring the current cell, according to some embodiments.

In other words, in the case of an MSIM device, the UE may have extra information about the registration status of the other MSIM instance for which UE may use to determine its action(s) when it receives non-IP reject cause #6 on the current instance (e.g., SIM). For example, if the MSIM UE receives a non-IP reject cause #6 Illegal ME on one MSIM instance first, then the other MSIM instance may be able to finish registration successfully. Furthermore, because the UE was able to register normally on MSIM_Instance_2, the UE may use this information on MSIM_Instance_1 to stop the T3245/T3247 timer started for DoS and proceed immediately with cell selection, according to some embodiments. Accordingly, this may provide a measure of power conservation by bypassing or proactively stopping the T3245/T3247 timer which may, if unstopped, result in registration delays, according to some embodiments.

For example, according to further embodiments related to FIG. 13, a method by a UE may include operating in a MSIM mode and transmitting, using a first radio associated with a first SIM, a first registration request to a network node. The method may further include transitioning, based at least in part on performing a successful registration procedure associated with a first cell of the network node, the first SIM to a registered idle state and transmitting, using a second radio associated with a second SIM, a second registration request to the network node. The method may additionally include receiving, using the second radio, a registration reject message from the network node. In some embodiments, the registration reject message may include a registration reject cause code associated with a second cell of the network node. The method may further include barring the second cell and performing a cell selection procedure in which the second cell is barred from being selected in the cell selection procedure. According to some embodiments, the registration reject message may be a non-IP registration reject message.

In some embodiments related to FIG. 13, the first SIM may instead be MSIM_Instance_2 and the second SIM may be MSIM_Instance_1 such that their roles are reversed with regard to the methods performed in 1302-1310.

FIG. 14 is a communication flow diagram illustrating an alternate method for power saving in a scenario in which one SIM is operating in a normal registered state and the other SIM has received a non-integrity protected registration reject message, according to some embodiments.

For example, in 1402 a UE may power up in a MSIM mode and a second SIM (e.g., MSIM_Instance_2) may send a registration request to a network in 1404. Additionally in 1406, MSIM_Instance_2 may receive a non-IP registration reject cause #6, Illegal ME message from the network. However, in 1408, if the MSIM_Instance_2 has a T3245 timer configured, MSIM_Instance_2 may start the T3245 timer and mark the USIM as invalid for the duration (e.g., until expiry) of the timer, according to some embodiments. Alternatively, if the MSIM_Instance_2 does not have a T3245 timer configured, MSIM_Instance_2 may start a T3247 timer, increment a counter, mark the TA as forbidden, and search for another TA, according to some embodiments.

Additionally, in 1410, MSIM_Instance_1 may be able to attach and move to a registered idle state. Accordingly, once the UE becomes aware that MSIM_Instance_1 has been able to register successfully, in 1412 MSIM_Instance_2 may stop either the T3245 or T3247 timer and start cell selection immediately and barring the current serving cell. In other words, if the MSIM UE may receive a non-integrity protected reject cause #6 “Illegal ME” on one MSIM instance and the other MSIM Instance is able to registered successfully, the UE may simply ignore the non-IP reject message received on the current MSIM instance and proceed with a cell selection procedure in which the current serving cell is barred, according to some embodiments.

For example, a method related to FIG. 14 may include, starting, upon reception of the registration reject message, one or more timers. In some embodiments, the one or more timers may include a T3245 timer and the method may further include marking the second SIM as invalid for a duration of the T3245 timer. Additionally or alternatively, the one or more timers may include a T3247 timer and the method may further include incrementing a counter of the timer, marking a tracking area (TA) associated with the second cell as forbidden, and searching for a TA other than the forbidden TA. In some embodiments, the registration reject cause code may be a Registration Reject Cause #6 associated with an illegal mobile equipment (ME).

In some embodiments related to FIG. 14, the first SIM may instead be MSIM_Instance_2 and the second SIM may be MSIM_Instance_1 such that their roles are reversed with regard to the methods performed in 1402-1412.

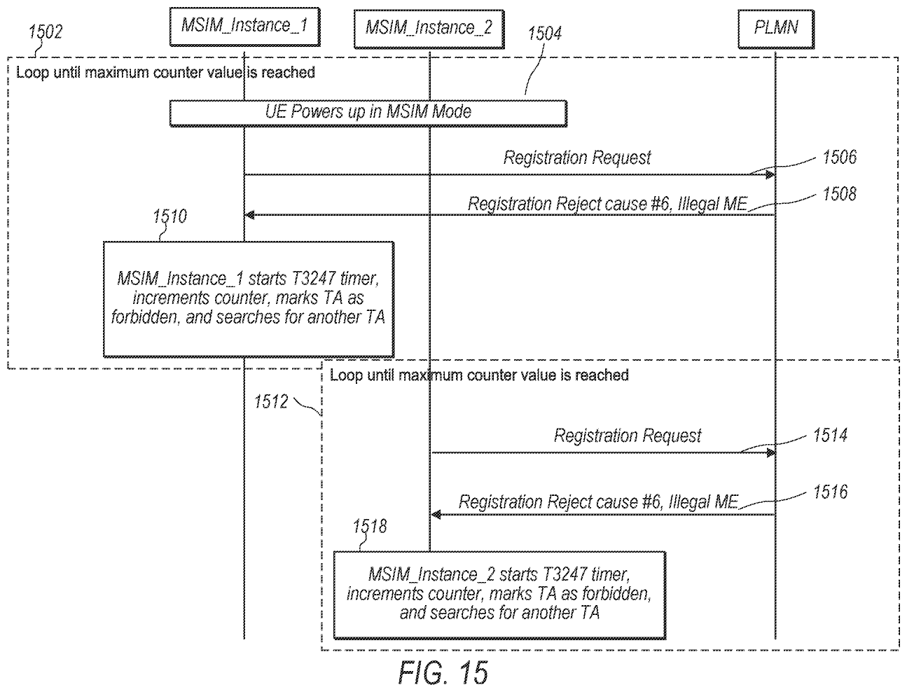

### FIG. 15—MSIM Looping Operations Involving Non-Integrity Protected Registration Reject Messages

FIG. 15 is a communication flow diagram illustrating example aspects of MSIM device operations in which both SIMs from the same PLMN follow a looping procedure after receiving a non-integrity protected registration reject message, according to some embodiments.

For example, in 1502, a UE may perform a looping procedure (e.g., a cyclic mechanism or method) until a maximum counter value is reached. In other words, upon each completion of the loop involving 1504, 1506, 1508, and 1510, a counter may be incremented until a maximum value is reached. When the maximum value is reached, the looping procedure may cease, according to some embodiments. More specifically, the looping procedure may include 1504 in which a UE may power up in a MSIM mode and a first SIM (e.g., MSIM_Instance_1) may send a registration request to a PLMN in 1506. Additionally in 1508, MSIM_Instance_1 may receive a non-IP registration reject cause #6, Illegal ME message from the PLMN. Accordingly, if the MSIM_Instance_1 does not have a T3245 timer configured, MSIM_Instance_2 may start a T3247 timer, increment a counter, mark the TA as forbidden, and search for another TA, according to some embodiments. Furthermore, if the maximum value of the counter has not been reached, the UE may proceed back to an appropriate start of the 1502 looping procedure (e.g., 1504 or 1506), according to some embodiments.

Additionally in 1512, the UE may perform a second looping procedure associated with MSIM_Instance_2 and upon each completion of the loop involving 1514, 1516, and 1588, a counter may be incremented until a maximum value is reached. When the maximum value is reached, the 1512 looping procedure may cease, according to some embodiments.

More specifically, the 1512 looping procedure may include 1514 in which MSIM_Instance_2 may send a registration request to the same PLMN. Additionally in 1516, MSIM_Instance_2 may receive a non-IP registration reject cause #6, Illegal ME message from the PLMN. Accordingly, if the MSIM_Instance_2 does not have a T3245 timer configured, MSIM_Instance_2 may start a T3247 timer, increment a counter, mark the TA as forbidden, and search for another TA, according to some embodiments. Furthermore, if the maximum value of the counter has not been reached, the UE may proceed back to an appropriate start of the 1502 looping procedure (e.g., 1504 or 1506), according to some embodiments. At least in some instances, these 1502 and 1512 looping procedures of the SIMs may result in a greater number of signaling attempts from the MSIM device and therefore increase the signaling load on the network.

In other words, when an MSIM UE receives a non-IP reject cause code #6 “Illegal ME” on both MSIM instances from the same PLMN and the UE is not configured to use T3245 timers, each MSIM Instance (e.g., the first and second SIMs MSIM_Instance_1 and MSIM_Instance_2) may independently maintain counters for a “SIM/USIM considered invalid for GPRS services” event. Additionally, the first and second SIMs may increment the counter for each rejection from the network until they reach a maximum value. Accordingly, both SIMs may then keep searching for another cell in different TA.

Accordingly, while it is possible for MSIM devices to run DoS specific counters and timers individually on both MSIM instances as if they were two single SIM devices, this may result in decreased efficiency and power conservation of both the MSIM device and network. Accordingly, it may be beneficial in this scenario to treat both MSIM instances as one device and have one counter for both SIMs, according to some embodiments.

In some embodiments related to FIG. 15, the first SIM may instead be MSIM_Instance_2 and the second SIM may be MSIM_Instance_1 such that their roles are reversed with regard to the methods performed in 1502-1518.

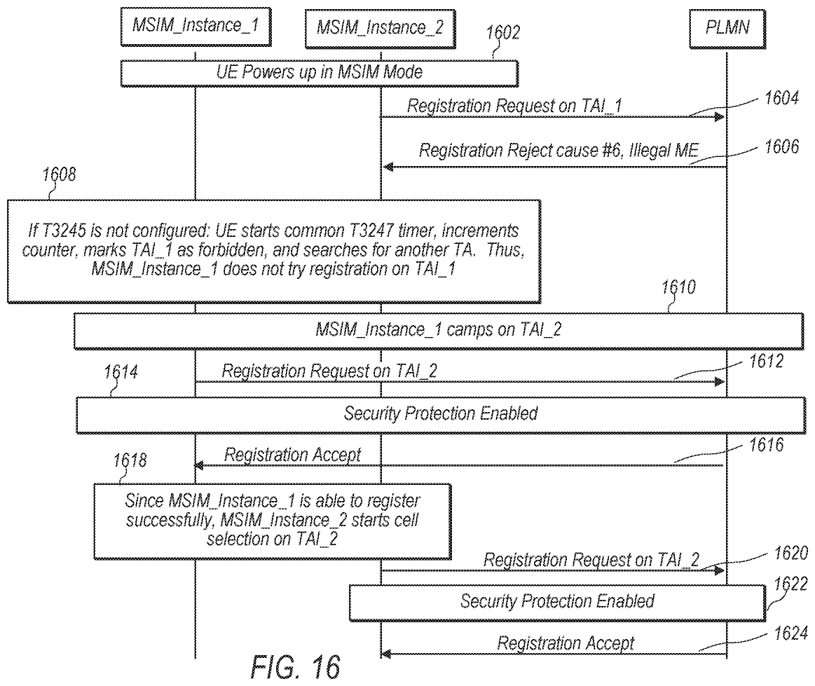

### FIG. 16—Power Saving Methods for MSIM Operation Involving Non-Integrity Protected Registration Reject Messages in Tracking Areas

FIG. 16 is a communication flow diagram illustrating an example method for power saving in a scenario in which one SIM receives a non-integrity protected registration reject message and attempts to camp in a second tracking area, according to some embodiments.

For example, in 1602, a UE may power up in a MSIM mode and a first SIM (e.g., MSIM_Instance_2) may send a registration request associated with a first tracking area identifier (TAI_1) to a PLMN in 1604. Additionally in 1606, MSIM_Instance_2 may receive a registration reject cause #6, Illegal ME message from the PLMN. Accordingly, in 1608, if the MSIM_Instance_2 does not have a T3245 timer configured, MSIM_Instance_2 may start a common T3247 timer (e.g., common to a second SIM (e.g., MSIM_Instance_1) and MSIM_Instance_2), increment a counter, mark the TAI_1 as forbidden, and search for another TA, according to some embodiments. Furthermore, as the UE may now be aware that TAI_1 is forbidden, MSIM_Instance_1 may not attempt registration on TAI_1, according to some embodiments.

Instead, at 1610, MSIM_Instance_1 may attempt to camp on a second TAI (e.g., TAI_2) and transmit a registration request associated with TAI_2 to the PLMN in 1612. Furthermore, at 1614, security protection may be enabled and the PLMN may transmit a registration accept message to MSIM_Instance_1 at 1616. Accordingly, in 1618, the UE (e.g., and therefore its associated MSIM instances) may be aware that MSIM_Instance_1 was able to register with the PLMN successfully on TAI_2 and therefore MSIM_Instance_2 may start cell selection on TAI_2. Thus, at 1620, MSIM_Instance_2 may transmit a registration request associated with TAI_2 to the PLMN. Furthermore, at 1622, security protection may be enabled and the PLMN may transmit a registration accept message to MSIM_Instance_2 at 1624.

In other words, both MSIM instances may be associated with single UE and both instances may have the same operator SIM which may allow for the one MSIM instance to perform actions in response to another MSIM instance's action(s). Accordingly, it may be possible to have a single timer to maintain a common counter for “SIM/USIM considered invalid for GPRS services” events and a shared “5GS forbidden tracking areas for roaming” list for non-integrity protected NAS reject messages.

For example, and related to FIG. 16, if one MSIM instance is able to register successfully, the other MSIM instance may trigger a registration on the same TAI. However, if either instance fails to register due to a non-integrity protected reject cause code #6 “Illegal ME”, the UE may restart the common T3247 timer and update the common counter for “SIM/USIM considered invalid for GPRS services” event. Additionally the UE may update the TAI in a shared “5GS forbidden tracking areas for roaming” list for non-integrity protected NAS reject messages. In this scenario, it may be beneficial to set a maximum number of attempts per device (e.g., 10 attempts as one example). Accordingly, if each instance was associated with a maximum number of 10 attempts, this would result in potentially 20 attempts per device and would be essentially redundant since both MSIM instances have the same operator SIM. Accordingly, a common timer may be used for both MSIM instances to reduce the number of registration attempts per device and further as a potential power saving method with reduced redundancy. In other words, it may be beneficial for a UE to use a single timer to maintain a common counter for “SIM/USIM considered invalid for GPRS services” events and a shared “5GS forbidden tracking areas for roaming” list for non-integrity protected NAS reject messages. Therefore, by maintaining the common timer and counter as well as a shared list of forbidden track areas, the MSIM instances of the UE may be able to more efficiently connect to a network and further conserve power through reduced communications.

Furthermore, according to embodiments related to FIG. 16, an apparatus may include at least one processor of a UE operating in a MSIM mode and the at least one processor may be configured to cause the UE to transmit, to a public land mobility network (PLMN) and using a first radio associated with a first SIM, a first registration request associated with a first tracking area identifier (TAI). The at least one processor may be further configured to cause the UE to receive, using the first radio, a registration reject message from the network node in which the registration reject message may include a registration reject cause code. The at least one processor may be further configured to cause the UE to start one or more timers, mark the first TAI as forbidden, and search for a second TAI excluding the first TAI.

In some embodiments, the at least one processor may be further configured to cause the UE to transmit, to the PLMN and using the second radio, a second registration request associated with the second TAI and receive, from the PLMN and using the second SIM, a registration accept message. The at least one processor is further configured to cause the UE to transmit, to the PLMN and using the first radio associated with the first SIM, a third registration request associated with the second TAI and receive, from the PLMN and using the first radio associated with the first SIM, a second registration accept message, according to some embodiments. Additionally or alternatively, the one or more timers may include a T3247 timer and the at least one processor may be further configured to cause the UE to increment a counter of the T3247 timer upon reception of a registration reject message from the PLMN. According to some embodiments, the registration reject message may be a non-IP non-access stratum (NAS) reject message.

In some embodiments, when the counter of the T3247 timer is incremented, the at least one processor may be further configured to cause the UE to update, upon reception of respective registration reject messages, a list of forbidden TAIs to include respective forbidden TAIs associated with the respective registration request messages. Additionally or alternatively, when the counter of the T3247 timer reaches a maximum value, the at least one processor may be further configured to cause the UE to perform a cell search procedure in a different TAI.

In some embodiments related to FIG. 16, the first SIM may instead be MSIM_Instance_1 and the second SIM may be MSIM_Instance_2 such that their roles are reversed with regard to the methods performed in 1602-1624.

### Example Embodiments

Still another example embodiment may include a device, comprising: an antenna; a radio coupled to the antenna; and a processing element operably coupled to the radio, wherein the device is configured to implement any or all parts of the preceding examples.

Yet another example embodiment may include a method, comprising: by a device: performing any or all parts of the preceding examples.

A further embodiment may include a non-transitory computer accessible memory medium comprising program instructions which, when executed at a device, cause the device to implement any or all parts of any of the preceding examples.

A still further example embodiment may include a computer program comprising instructions for performing any or all parts of any of the preceding examples.

A yet further example embodiment may include an apparatus comprising means for performing any or all of the elements of any of the preceding examples.

Still another example embodiment may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106 or BS 102) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A wireless device, comprising:
a first radio and a second radio;
at least one processor coupled to the first radio and the second radio and configured to cause the wireless device to:
transmit, using a first SIM associated with the first radio, a first attach request to a network node;
transmit, using a second SIM associated with the second radio, a second attach request to the network node;
receive, operating in a multiple-subscriber identity module (MSIM) mode, an attach reject message from the network node, wherein the attach reject message comprises an attach reject cause code;
transition, based at least in part on reception of the attach reject message, the second SIM to a limited service camped state;
disable the second radio;
transition to a single-SIM mode; and
communicate with the network node, wherein the communications are associated with the first SIM.

2. The wireless device of claim 1, wherein the attach reject cause code is an Attach Reject Cause #6 associated with an illegal mobile equipment (ME).

3. The wireless device of claim 1, wherein the limited service camped state provides emergency services for the wireless device.

4. The wireless device of claim 1, wherein the at least one processor is further configured to cause the wireless device to transition the second SIM out of the limited service camped state upon completion of a power cycle.

5. The wireless device of claim 1, wherein the attach reject message is non-integrity protected.

6. The wireless device of claim 1, wherein the at least one processor is further configured to cause the wireless device to:
receive, on the first SIM, an attach accept message from the network node;
transition, based at least in part on performing a successful registration procedure, to a registered idle state;
receive, on the second SIM, an authentication request from the network node;
transmit, on the second SIM, an authentication response to the network node; and
receive, on the second SIM, an authentication reject message from the network node;
wherein the second SIM is transitioned to the limited service camped state based at least in part on reception of the authentication reject message.

7. The wireless device of claim 6, wherein the first SIM provides emergency services and normal services based at least in part on being in the registered idle state.

8. A method, comprising:
by a user equipment (UE) operating in a multiple-subscriber identity module (MSIM) mode:
transmitting, using a first radio associated with a first subscriber identity module (SIM), a first registration request to a network node;
transitioning, based at least in part on performing a successful registration procedure associated with a first cell of the network node, the first SIM to a registered idle state;
transmitting, using a second radio associated with a second SIM, a second registration request to the network node;
receiving, using the second radio, a registration reject message from the network node, wherein the registration reject message comprises a registration reject cause code associated with a second cell of the network node;
barring the second cell; and
performing a cell selection procedure, wherein the second cell is barred from being selected in the cell selection procedure.

9. The method of claim 8, wherein the registration reject message is non-integrity protected registration reject message.

10. The method of claim 8, further comprising:
starting, upon reception of the registration reject message, one or more timers.

11. The method of claim 10, wherein the one or more timers comprise a T3245 timer and the method further comprises:
marking the second SIM as invalid for a duration of the T3245 timer.

12. The method of claim 10, wherein the one or more timers comprise a T3247 timer and the method further comprises:
incrementing a counter of the timer;
marking a tracking area (TA) associated with the second cell as forbidden; and
searching for a TA other than the forbidden TA.

13. The method of claim 8, wherein the registration reject cause code is a Registration Reject Cause #6 associated with an illegal mobile equipment (ME)

14. An apparatus, comprising:
at least one processor of a user equipment (UE) operating in a multiple-subscriber identity module (MSIM) mode, wherein the at least one processor is configured to cause the UE to:
transmit, to a public land mobility network (PLMN) and using a first radio associated with a first subscriber identity module (SIM), a first registration request associated with a first tracking area identifier (TAI);
receive, using the first radio, a registration reject message from the network node, wherein the registration reject message comprises a registration reject cause code;
start one or more timers;
mark the first TAI as forbidden; and
search for a second TAI excluding the first TAI.

15. The apparatus of claim 14, wherein the at least one processor is further configured to cause the UE to:
transmit, to the PLMN and using the second radio associated with the second SIM, a second registration request associated with the second TAI; and
receive, from the PLMN and using the second radio, a registration accept message.

16. The apparatus of claim 15, wherein the at least one processor is further configured to cause the UE to:
transmit, to the PLMN and using the first radio associated with the first SIM, a third registration request associated with the second TAI; and
receive, from the PLMN and using the first radio associated with the first SIM, a second registration accept message.

17. The apparatus of claim 14, wherein the one or more timers comprise a T3247 timer, and wherein the at least one processor is further configured to cause the UE to:
increment a counter of the T3247 timer upon reception of a registration reject message from the PLMN.

18. The apparatus of claim 17, wherein when the counter of the T3247 timer is incremented, the at least one processor is further configured to cause the UE to:
update, upon reception of respective registration reject messages, a list of forbidden TAIs to include respective forbidden TAIs associated with the respective registration request messages.

19. The apparatus of claim 17, wherein when the counter of the T3247 timer reaches a maximum value, the at least one processor is further configured to cause the UE to:
perform a cell search procedure in a different TAI.

20. The apparatus of claim 14, wherein the registration reject message is a non-integrity protected non-access stratum (NAS) reject message.
